(19) United States
(12) Patent Application Publication
(10) Pub. No.: US 2009/0153731 A1
(43) Pub. Date: Jun. 18, 2009

(54) Method for Processing an Interlaced Scanning Image

(76) Inventors: Chao-Wen Lin, Hsinchu City (TW); Jui-Hsin Hung, Hsinchu City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/254,047

(22) Filed: Oct. 20, 2008

(30) Foreign Application Priority Data
Dec. 14, 2007 (TW) 096148112

(51) Int. Cl. H04N 7/01

(52) U.S. Cl. 348/448; 348/E07.003

(57) ABSTRACT

A method for processing an interlaced scanning image that can eliminate the interference problem. The method for processing an interlaced scanning image comprises the steps of: obtaining an interlaced scanning image; defining a target zone from the interlaced scanning image; retrieving a plurality of scan lines of a first field of the target zone, wherein the first field can be odd field or even field; copying the plurality of scan lines of the first field to replace a second field of the target zone; performing an image process to the target zone; performing an image process to the whole image except the target zone; and consolidating the two processed images to a new one.

### BACKGROUND OF THE INVENTION

1. Field of the Invention

Processed interlaced scanning images may have interference phenomena because any two adjacent lines have time lag. The present invention relates to a method for reducing the interference of a processed interlaced scanning image.

2. Description of the Related Art

In general, image display methods for image device include interlaced scanning methods and progressive scanning methods. Currently, the interlaced scanning methods are more popular. The general interlaced method scans odd lines first, and then scans even lines. As shown in FIG. 1(a), each image frame is composed of a plurality of scan lines. The odd-line scan displays all odd lines to form an odd field, and the another scan displays all even lines to form an even field. That is, a complete image frame consists of the odd field and the even field. Because there is time lag between the odd field and even field, images on any two adjacent lines may not be continuous. The difference between two adjacent lines will be huge when image changes dramatically. That is, the interference may be more serious under certain condition. Here is an example shown in FIG. 1(a), (b). FIG. 1(a) is an interlaced scanning image. FIG. 1(b) is the result of FIG. 1(a) via image process.

Therefore, it is desirable to provide a method for processing an interlaced scanning image to mitigate and/or obviate the aforementioned problems.

### SUMMARY OF THE INVENTION

A main objective of the present invention is to provide a method to reduce the interference caused by processing an interlaced scanning image. An embodiment example of the present invention is to provide a method for calibrating fisheye images.

In order to achieve the above mentioned objective, the method of the present invention comprises the following steps:
(a) obtaining an interlaced scanning image;
(b) defining a target zone from the interlaced scanning image;
(c) retrieving a plurality of scan lines of a first field of the target zone;
(d) copying the plurality of scan lines of the first field to replace a second field of the target zone;
(e) performing an image process to the target zone;
(f) performing an image process to the area except the target zone; and
(g) consolidating the images from step (e) and step (f).

In the target zone, the first field may be an odd field or an even field, and the second field is another field. When objects in an image sequence move fast, since there is no time lag between two adjacent fields, each two adjacent scan lines of the image are continuous. Therefore, the interference of the target zone is eliminated and the clarity of the image in the target zone may be maintained.

As an embodiment example of the present invention, an interlaced scanning image is obtained by an image capturing device with a fisheye lens, and the image process is performed to the interlaced scanning image by the previous mentioned steps. Therefore, the interference of the processed image may be eliminated.

Other objective, advantages, and novel features of the invention will become more apparent from the following detailed description when taken in conjunction with the accompanying drawings.

### BRIEF DESCRIPTION OF THE DRAWINGS

FIGS. 1(a), (b) are images showing an interlaced scanning image before and after being processed.

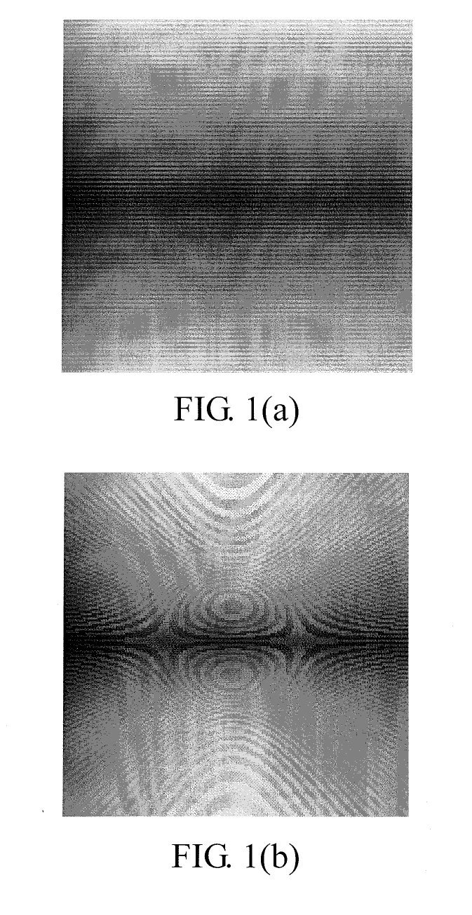

FIG. 2 is a flowchart of the method for an interlaced scanning image according to the present invention.

FIG. 3 is a schematic drawing of the method for an interlaced scanning image according to the present invention.

FIGS. 4(a), (b) are images of showing an interlaced scanning image before and after being processed by the method of the present invention.

### DETAILED DESCRIPTION OF THE PREFERRED EMBODIMENT

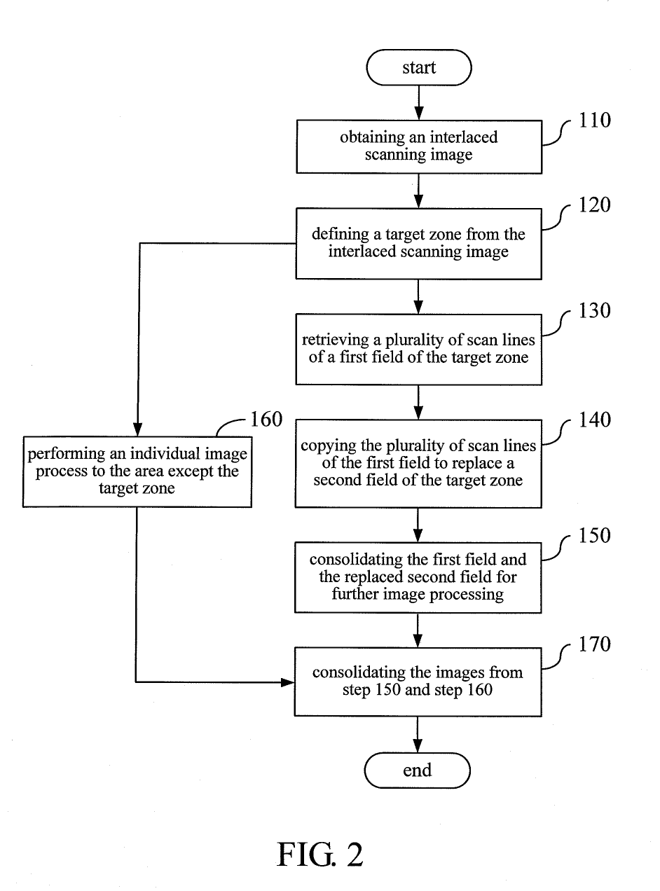

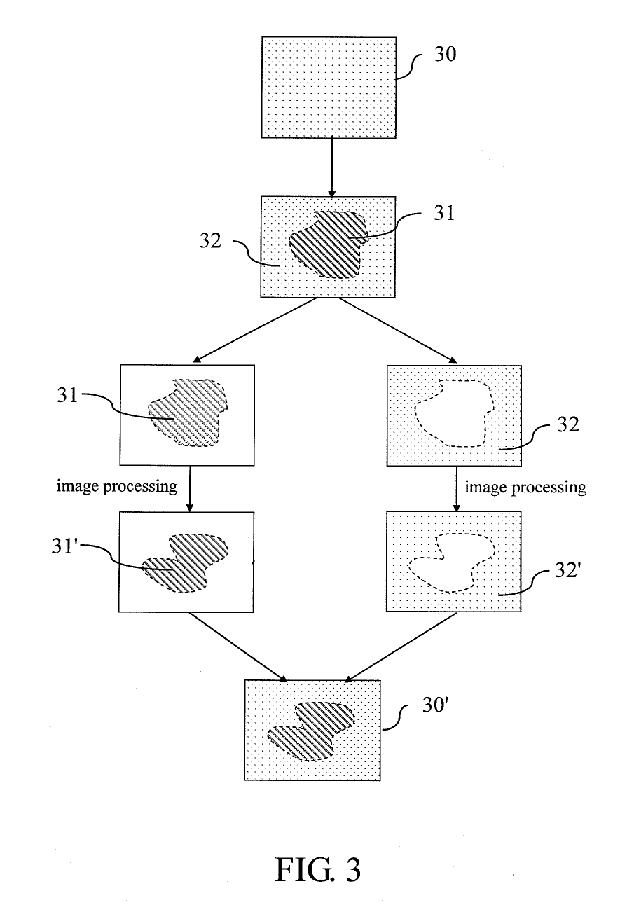

Please refer to FIG. 2 and FIG. 3. FIG. 2 is a flowchart of the method for an interlaced scanning image according to the present invention. FIG. 3 is a schematic drawing of the method for an interlaced scanning image according to the present invention. As shown in FIG. 2, a method for the interlaced scanning image process of the present invention comprises following steps:

Step 110: obtaining an interlaced scanning image. As shown in FIG. 3, an image device is used for obtaining an interlaced scanning image 30, and the image device may be a television, a video camera, or an image capturing device with a fisheye lens or other similar image devices.

Step 120: defining a target zone from the interlaced scanning image. As shown in FIG. 3, in order to eliminate the interference from the image, a target zone 31 should be defined. The area of the target zone 31 may be partial of or entire of the interlaced scanning image 30. For example, for a television display picture, the target zone 31 may be defined as the entire interlaced scanning image 30; for a image capturing device with a fisheye lens (such as a rear view camera of a car), the important area would be the center area which will have more serious interference after the image process, therefore the target zone 31 may be defined at the center area of the image.

Step 130: retrieving a plurality of scan lines of a first field of the target zone 31. A first field may be an odd field or an even field, and a second field is another field.

Step 140: copying the plurality of scan lines of the first field to replace a second field of the target zone 31.

Step 150: consolidating the first field and the replaced second field for further image processing. After the second field of the target zone 31 is replaced by the first field of the target zone 31, each two adjacent scan lines in the target zone 31 will be continuous. The interference will not be generated by any moving objects or dramatic change in the image. An image process is performed to the target zone 31 to form a new target zone 31′ and eliminate the interference caused by different fields.

Step 160: performing an individual image process to the area 32 which is the interlaced scanning image 30 excluding the target zone 31. An individual image process needs to be performed to the area 32. Since the interlaced scanning image 30 might have image deformation in further image process, an individual image process needs to be performed to the area 32 except the target zone 31 to form a new area 32′.

Step 170: consolidating the images from step 150 and step 160. An image process is performed to eliminate the interference for the defined target zone 31 in step 150 to form the new target zone 31′, and an individual image process is performed to the area 32 in step 160 to form a new area 32′. Then the images of the new target zone 31′ and the new area 32′ are consolidated and become a whole image 30′. Meanwhile, the interference of the image in the new target zone 31′ has been eliminated.

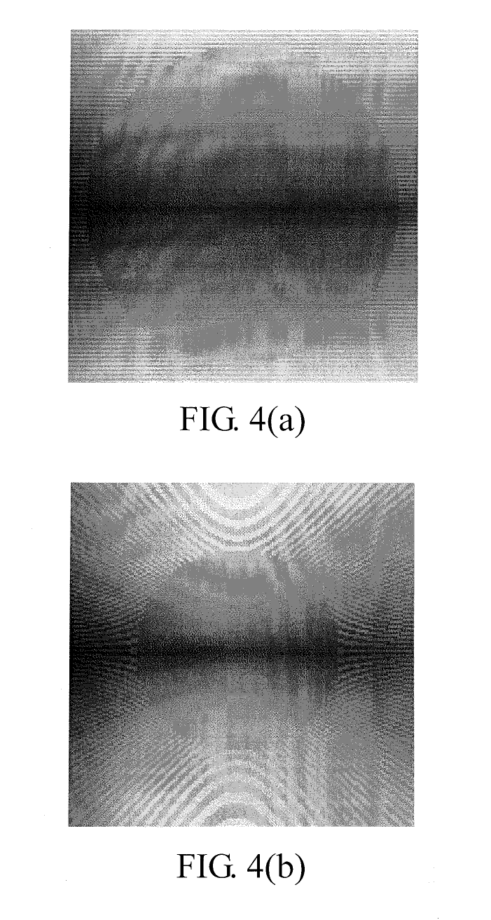

Please refer to FIGS. 4(a), (b). FIGS. 4(a), (b) are images of showing an interlaced scanning image before and after being processed by the method according to the present invention. FIG. 4(a) shows an original interlaced scanning image. The center area of the interlaced scanning image is selected to be the target zone, and the method for processing the interlaced scanning image of the present invention performs the image process to the target zone to obtain the processed interlaced scanning image shown in FIG. 4(b). Therefore, the interference of the target zone is eliminated and the clarity of the image of the target zone may be maintained.

Furthermore, the present invention is applied to reduce the interference of calibrated fisheye images. An interlaced scanning image is obtained by an image capturing device with a fisheye lens, and the image process is performed to the interlaced scanning image by the previous mentioned steps. Therefore, the interference of the series images obtained by the image capturing device with a fisheye lens may be eliminated and the clarity of the image of the target zone may be maintained. This method for calibrating fisheye images may be applied to a rear view camera of a car or other image capturing device.

Although the present invention has been explained in relation to its preferred embodiment, it is to be understood that many other possible modifications and variations can be made without departing from the spirit and scope of the invention as hereinafter claimed.

What is claimed is:

1. A method for processing an interlaced scanning image comprising the following steps:
(a) obtaining an interlaced scanning image;
(b) defining a target zone from the interlaced scanning image;
(c) retrieving a plurality of scan lines of a first field of the target zone;
(d) copying the plurality of scan lines of the first field to replace a second field of the target zone;
(e) performing an image process to the target zone;
(f) performing an image process to the area except the target zone; and
(g) consolidating the images from step (e) and step (f).

2. The method as claimed in claim 1, wherein the first field is an odd field and the second field is an even field; or the first field is an even field and the second field is an odd field.

3. The method as claimed in claim 1, wherein the target zone may be a partial image or a whole image.

4. The method as claimed in claim 1, wherein the interlaced scanning image may be obtained by a television, a video camera, or an image capturing device with a fisheye lens.

5. A method for calibrating fisheye images comprising the following steps:
(a) obtaining an interlaced scanning image by an image capturing device with a fisheye lens;
(b) defining a target zone from the interlaced scanning image
(c) retrieving a plurality of scan lines of a first field of the target zone;
(d) copying the plurality of scan lines of the first field to replace a second field of the target zone;
(e) performing an image process to the target zone;
(f) performing an image process to the area except the target zone; and
(g) consolidating the images from step (e) and step (f).

6. The method as claimed in claim 5, wherein the first field is an odd field and the second field is an even field; or the first field is an even field and the second field is an odd field.
